(19) United States
(12) Patent Application Publication
(10) Pub. No.: US 2010/0306331 A1
(43) Pub. Date: Dec. 2, 2010

(54) PRINTER, INFORMATION PROCESSING SYSTEM, INFORMATION PROCESSING METHOD, AND COMPUTER-READABLE RECORDING MEDIUM HAVING RECORDED PROGRAM

(75) Inventor: Moriaki SUGIMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/791,121

(22) Filed: Jun. 1, 2010

(30) Foreign Application Priority Data
Jun. 1, 2009 (JP) 2009-132127

(51) Int. Cl. G06F 15/16

(52) U.S. Cl. 709/206

(57) ABSTRACT

A printer connected to an information processing device via a network so as to communicate with the information processing device and a method of controlling a printer. The printer includes, a receiving unit configured to receive first information including a transmission destination address from the information processing device in accordance with a printing request from the information processing device, an information obtaining unit configured to obtain information relating to at least one of a state of the printer and the printing request from the information processing device and an electronic mail transmission unit configured to transmit second information via an electronic mail to the transmission destination address included in the first information received in accordance with the printing request from the information processing device, the second information relating to the at least one of the printing request and the state of the printer.

### CROSS-REFERENCE TO RELATED APPLICATIONS

This application is based upon and claims the benefit of priority of the prior Japanese Patent Application No. 2009-132127, filed on Jun. 1, 2009, the entire contents of which are incorporated herein by reference.

### BACKGROUND

Some printers or printer state management devices connected to external devices via networks to communicate with the external devices are capable of holding print data in mailboxes configured in printers, and others have an electronic mail transmission function for transmitting electronic mail to the external devices.

For example, some typical information processing devices configured to generate print data are capable of setting a mailbox mode in which the print data is accumulated in a printer without being printed and a printer output mode in which print data received by the printer is sequentially printed.

A typical printer state management device is configured to obtain status information about a printer from a client computer and to transmit information such as information about the occurrence of an error to a transmission destination address set in advance by a user via electronic mail (electronic mail transmission function). The printer state management device includes a client management database including a transmission destination address set in advance by a user.

### SUMMARY

According to an embodiment, a printer is connected with an information processing device via a network so as to communicate with the information processing device. The printer includes, a receiving unit configured to receive first information including a transmission destination address from the information processing device in accordance with a printing request from the information processing device, an information obtaining unit configured to obtain information relating to at least one of a state of the printer and the printing request from the information processing device and an electronic mail transmission unit configured to transmit second information via an electronic mail to the transmission destination address included in the first information received in accordance with the printing request from the information processing device, the second information relating to the at least one of the printing request and the state of the printer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an information processing system including printers, client terminal(s), and a mail server according to an embodiment.

FIG. 2 is a block diagram illustrating a configuration of a client terminal and a printer according to an embodiment.

FIG. 3 is a diagram illustrating an example of an input screen displayed on a display panel of a display device by executing a printer driver.

FIG. 4 is a flowchart illustrating an overall process regarding transmission of electronic mail, which may be performed by a printer according to an embodiment.

FIG. 5 is a flowchart further describing a portion of the process illustrated in FIG. 4.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Various embodiments of an information processing system including a printer will be described hereinafter.

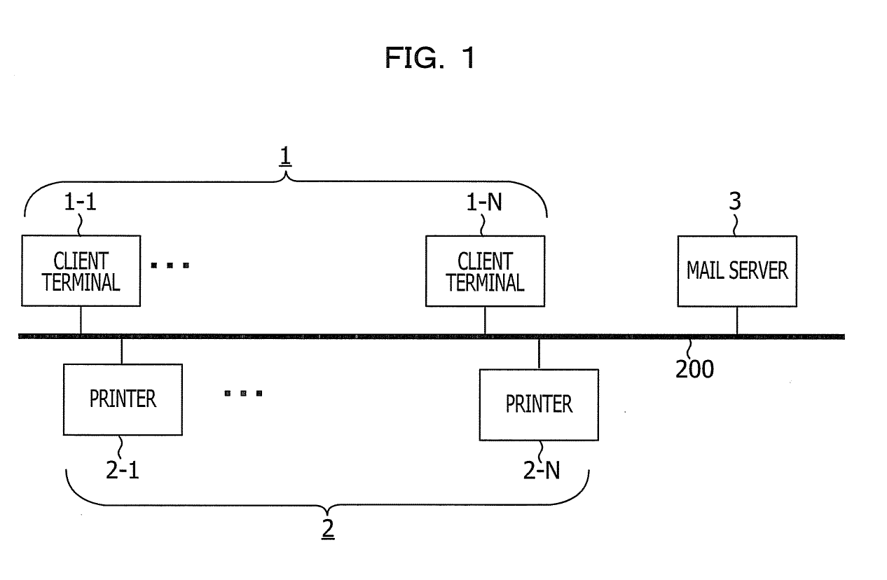

FIG. 1 is a diagram illustrating an information processing system including printers, client terminals, and a mail server.

In FIG. 1, client terminals 1-1 to 1-N (client terminals 1) may be information processing devices such as personal computers (PCs), or other similar devices, etc. and are connected to a network 200. A mail server 3 may be a device configured to transfer electronic mail, and is connected to the network 200. In this case, each of the users of the client terminals 1-1 to 1-N has an electronic mail address, and the mail server 3 sorts electronic mail messages based on their electronic mail addresses when the client terminals 1-1 to 1-N access the mail server 3. Information including electronic mail messages is transmitted from printers 2-1 to 2-N (printers 2) to the client terminals 1-1 to 1-N via the mail server 3.

In FIG. 1, each of the printers 2-1 to 2-N (printers 2) has an electronic mail transmission function and is configured to transmit, in accordance with a print job (printing request), information relating to at least one of the print job and a state of the printer to the transmission destination addresses transmitted from the client terminals 1-1 to 1-N together with print data.

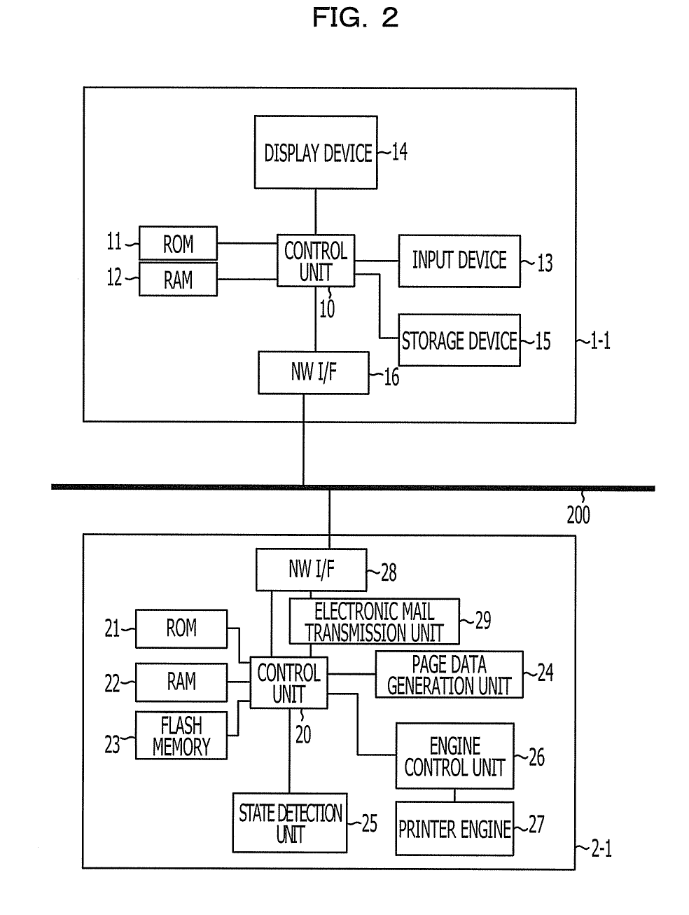

The configuration of a client terminal and a printer will now be described with reference to FIG. 2. FIG. 2 is a block diagram illustrating a configuration of the client terminal 1-1 and the printer 2-1, by way of example. However, the other client terminals and printers generally have a configuration similar to that illustrated in FIG. 2.

Referring to FIG. 2, the client terminal 1-1 includes a control unit 10, a read-only memory (ROM) 11, a random access memory (RAM) 12, an input device 13, a display device 14, a storage device 15, and a network interface (NW I/F) 16.

The ROM 11 may be a non-volatile memory configured to store various program(s) for causing the client terminal 1-1 to execute information process(es). The RAM 12 may be a volatile memory serving as a main memory, a work area, or the like of the control unit 10. The input device 13 includes an input driver, and a keyboard or a pointing device (not illustrated), and receives an input from a user. The display device 14 includes a display driver and a display panel (not illustrated), and is configured to display information such as an image on the display panel in accordance with an instruction from the control unit 10. The storage device 15 stores a boot program, a printer driver program, various application programs, font data, user files, etc., and may be, for example, a hard disk drive (HDD).

In FIG. 2, the control unit 10 includes a microcontroller, and is configured to totally control the internal units of the client terminal 1-1. For example, the control unit 10 processes a document including a figure, an image, text, a table, and the like in accordance with a document processing program serving as an application program. The control unit 10 further executes the printer driver program (hereinafter referred to as a “printer driver”) in accordance with an instruction given by a user through the input device 13, and accepts specifying of at least the following information items (1) to (3):

(1) Printing condition(s) such as paper size, paper feed tray, resolution, and the number of prints.
(2) Transmission condition(s) relating to at least one of a print job of a document to be printed and the state of a printer and indicating whether or not electronic mail is to be transmitted.
(3) The transmission destination address of electronic mail to be transmitted when a transmission condition is satisfied.

A printing condition, a transmission condition, and a transmission destination address may be specified in advance in accordance with a rule or may be input by a user through the input device 13.

A printer driver is selected using an application, and printing is executed to generate print data and print-related data. The print data includes image data to be printed and a printing condition. The print-related data (first information) includes a transmission condition relating to at least one of the print job and the state of the printer, and the transmission destination address.

The control unit 10 executes printing in accordance with an input instruction for printing a document. Thus, print data and print-related data are generated and are temporarily registered in a spooler. Then, the print data and the print-related data are transmitted to one of the printers 2-1 to 2-N via the network interface 16.

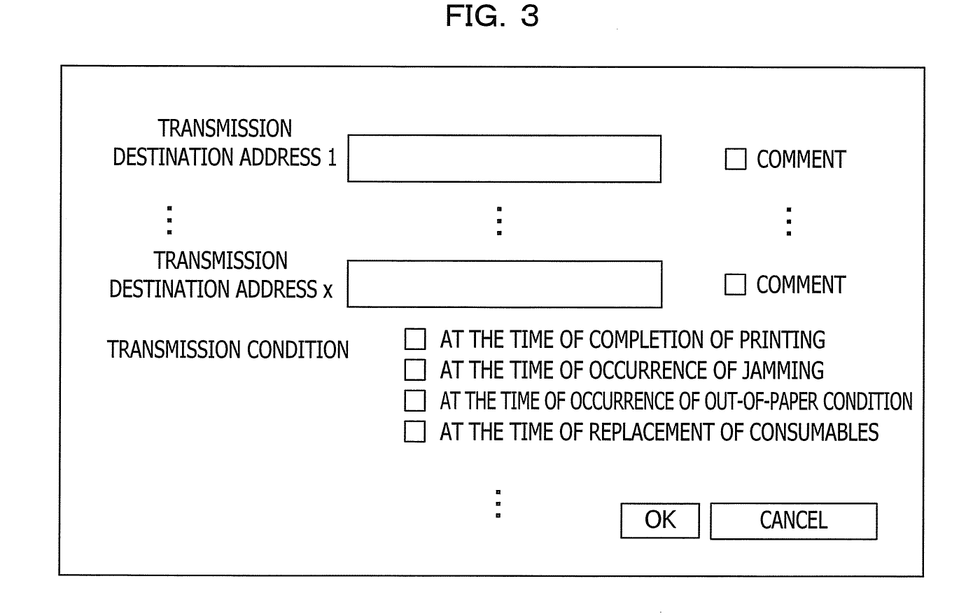

FIG. 3 illustrates an example of an input screen of a printer driver, which is displayed on the display panel of the display device 14 when a printer driver is selected and executed using an application. The input screen is used to accept specifying of a printing condition, a transmission condition, and a transmission destination address. In the example illustrated in FIG. 3, a plurality of transmission conditions are provided, including a transmission condition “at the time of completion of printing” as a transmission condition relating to a print job and transmission conditions “at the time of occurrence of jamming”, “at the time of occurrence of out-of-paper condition” and “at the time of replacement of consumables” as transmission conditions relating to the state of the printer. Here, for example, the transmission condition “at the time of completion of printing” is specified. In this case, as described below, the transmission condition is satisfied at the time when the printer completes printing, and electronic mail indicating the satisfaction of the transmission condition (for example, electronic mail including a character string “printing has been completed”) is transmitted to the specified transmission destination address.

As illustrated in FIG. 3, the user of a client terminal may be able to input a comment (character string) for each transmission destination address. In this case, the print-related data described above is generated so as to include the input comment. In the example illustrated in FIG. 3, it is assumed that when a user clicks on a checkbox named comment on the screen, a new window for allowing the user to input a comment is displayed.

Furthermore, character string information such as a transmission destination address and a comment is transferred to the printer as encrypted information so as not to allow a third party to readily recognize the information.

In FIG. 2, the printer 2-1 includes a control unit 20, a ROM 21, a RAM 22, a flash memory 23, a page data generation unit 24, a state detection unit 25, an engine control unit 26, a printer engine 27, a network interface (NW I/F) 28, and an electronic mail transmission unit 29.

The ROM 21 may be non-volatile memory configured to store various programs for causing the printer 2-1 to execute information processes. The RAM 22 may be a volatile memory serving as a main memory, a work area, or the like of the control unit 20 and including a page memory configured to store image data to be printed. The flash memory 23 may be a non-volatile memory configured to store maintenance-related information (such as error log information and parts replacement record information) about the printer 2-1.

The state detection unit 25 includes a plurality of sensors configured to detect the states of the internal units of the printer 2-1. The state detection unit 25 includes, for example, a sensor for detecting an occurrence of jamming (paper jam), a sensor for detecting an opening or closing of a cover of the housing of the printer 2-1, a sensor for detecting a state of mounted supplies such as paper, and a sensor for detecting a remaining amount of consumables such as ink cartridge. The outputs of the above sensors are successively transmitted to the control unit 20 as printer state data (second information). The printer state data may be implemented using status codes assigned in advance based on the resulting outputs of the sensors.

The engine control unit 26 controls driving of the printer engine 27 in accordance with an instruction of the control unit 20. Specifically, the engine control unit 26 sequentially transfers page data generated by the page data generation unit 24 to the printer engine 27, and also sets a printing condition recognized by the control unit 20 in the printer engine 27 to control processes such as paper feed, paper transportation, transfer, fixation, and discharge. Further, the engine control unit 26 successively transmits print job data relating to a print job (for example, information as to whether or not printing has been completed; second information), which is sent from a client terminal, to the control unit 20.

The control unit 20 includes a microcontroller, and is configured to totally control the internal units of the printer 2-1. For example, the control unit 20 analyzes print data received from a client terminal via the network interface 28, and recognizes a printing condition such as paper size, paper feed tray, resolution, or the number of prints. The control unit 20 develops the image data to be printed, which is included in the print data, on the page memory (the RAM 22). The page data generation unit 24 converts the image data to be printed into image data (the page data described above) corresponding to the printing condition recognized by the control unit 20 in accordance with the paper size, the resolution, or the like, and holds the image data in compressed form.

The control unit 20 analyzes the print-related data received together with the print data, and controls the electronic mail transmission unit 29 so that when an individual transmission condition included in the print-related data is satisfied, electronic mail indicating the satisfaction of the transmission condition is transmitted to the transmission destination address included in the print-related data. In this case, the control unit 20 provides the electronic mail transmission unit 29 with a character string indicating the satisfaction of the transmission condition and the transmission destination address. The determination of whether or not a transmission condition is satisfied is based on at least one of the print job data received from the engine control unit 26 and the printer state data received from the state detection unit 25.

For example, when the transmission condition “at the time of completion of printing” is satisfied based on the print job data, the control unit 20 provides the electronic mail transmission unit 29 with a character string “the printer 2-1 has completed printing” and the transmission destination address. When the transmission condition “at the time of occurrence of jamming” is satisfied based on the printer state data, the control unit 20 provides the electronic mail transmission unit 29 with a character string “a paper jam has occurred in the printer 2-1” and the transmission destination address. The character string to be provided to the electronic mail transmission unit 29 may be set in advance for each transmission condition.

The electronic mail transmission unit 29 generates electronic mail in accordance with the Simple Mail Transfer Protocol (SMTP), and transmits the electronic mail to the transmission destination address. The electronic mail may be generated based on the character string and transmission destination address provided by the control unit 20.

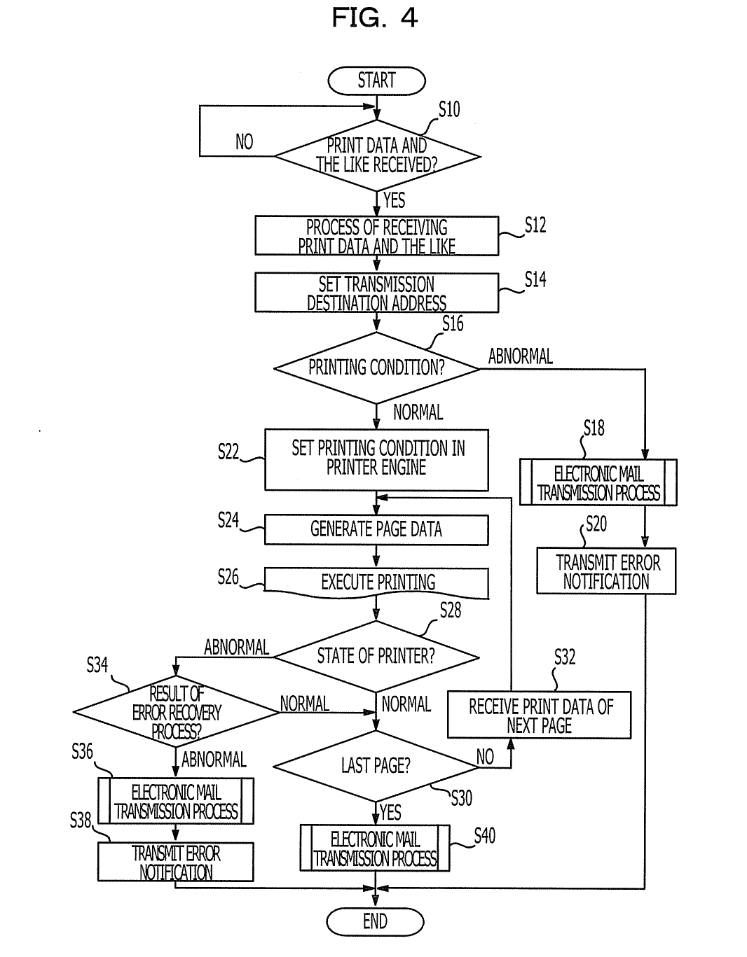

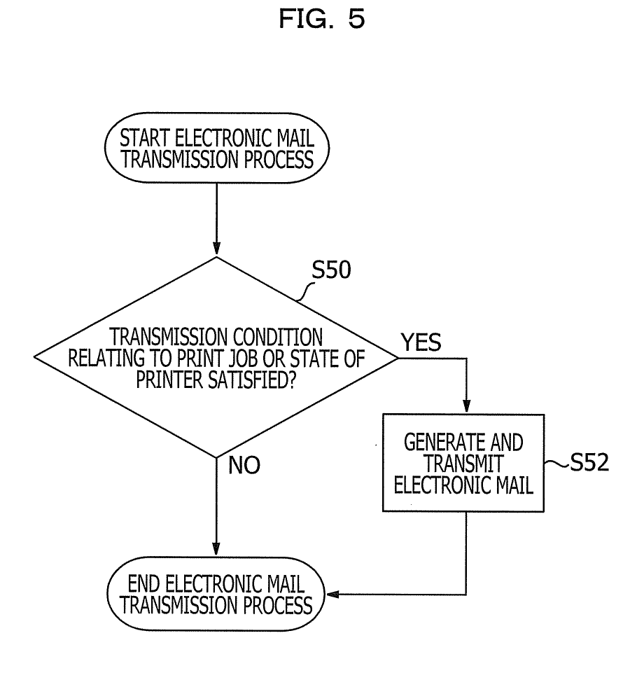

Next, an operation of a printer according to the present embodiment, in particular, an operation regarding transmission of electronic mail, will be described with reference to FIGS. 4 and 5. FIG. 4 is a flowchart illustrating an overall process regarding transmission of electronic mail, which is performed by a printer according to the present embodiment. FIG. 5 is a flowchart further describing a portion of the process illustrated in FIG. 4. The flowcharts illustrated in FIGS. 4 and 5 are executed mainly by the control unit 20 of the printer.

Referring to FIG. 4, when the printer receives print data and print-related data (in FIG. 4, represented as “print data and the like”) from an information processing device via the network interface 28 (Operation S10), a process for receiving print data and the like is performed (Operation S12). Specifically, the control unit 20 of the printer analyzes the received print data, and recognizes a printing condition such as paper size, paper feed tray, resolution, or the number of prints. The control unit 20 also analyzes the received print-related data, and sets a transmission destination address (Operation S14).

Then, the control unit 20 checks the recognized printing condition (Operation S16). Specifically, the control unit 20 determines, based on the printer state data received from the state detection unit 25, whether or not printing is executable in accordance with the printing condition. For example, when running out of paper in the paper feed tray specified by the printing condition is recognized based on the printer state data, the control unit 20 determines that the printer is in an “abnormal” state because printing is not executable, and proceeds to Operation S18. When it is determined that printing is executable in accordance with the printing condition, the control unit 20 determines that the printer is in a “normal” state, and proceeds to Operation S22.

In Operation S18, the control unit 20 executes an electronic mail transmission process illustrated in FIG. 5. Then, the control unit 20 transmits an error notification to the information processing device that has issued the printing request (Operation S20).

Here, the electronic mail transmission process will now be described with reference to FIG. 5. The control unit 20 analyzes the print-related data received in Operation S12, and determines whether or not a transmission condition (condition relating to the print job or the state of the printer) included in the print-related data is satisfied (Operation S50). Here, the determination of whether or not a transmission condition is satisfied is based on the printer state data received from the state detection unit 25. When it is determined in Operation S50 that a transmission condition is satisfied, a process for generating and transmitting electronic mail is performed (Operation S52). Specifically, the control unit 20 provides the electronic mail transmission unit 29 with a character string indicating the satisfaction of the transmission condition (a character string assigned in advance to the transmission condition) and the transmission destination address. Then, the electronic mail transmission unit 29 generates electronic mail based on the character string and transmission destination address provided by the control unit 20, and transmits the electronic mail to the transmission destination address.

When it is determined by the control unit 20 as a result of the analysis of the print-related data that the print-related data has a comment (character string), the comment is written in the body of the electronic mail.

Referring back to FIG. 4, in Operation S22, the engine control unit 26 sets the printing condition recognized by the control unit 20 in the printer engine 27 to control processes such as paper feed, paper transportation, transfer, fixation, and discharge. Then, the page data generation unit 24 generates, based on the printing condition recognized by the control unit 20, page data from image data to be printed, which is included in the print data received in Operation S12 (Operation S24). The page data is held in the page data generation unit 24 in compressed form.

When page data is generated, the engine control unit 26 and the printer engine 27 operate and printing is executed in accordance with an instruction of the control unit 20 (Operation S26). Here, the page data generated in the page data generation unit 24 is supplied to the engine control unit 26 on a page-by-page basis, and is printed using the printer engine 27.

During printing, the control unit 20 successively monitors the state of the printer (Operation S28). Specifically, the control unit 20 constantly obtains the state of the internal units of the printer based on the printer state data received from the state detection unit 25. Then, when it is determined that the printer is in an “abnormal” state, the control unit 20 proceeds to Operation S34. Here, if an error recovery process is confirmed (“NORMAL” in Operation S34), the same process as that performed when it is determined in Operation 828 that the printer is in a “normal” state is performed subsequently. The error recovery process may be a process for, for example, when it is determined that the printer is in an “abnormal” state due to the occurrence of jamming, then overcoming the “abnormal” state of the printer by removing paper jammed in the printer. When the error recovery process is not confirmed, it is determined again that the printer is still in an “abnormal” state. Then, the control unit 20 proceeds to Operation S36, and an electronic mail transmission process is performed. The processing of Operation S36 has been described with reference to FIG. 5, and is not described here. After electronic mail is transmitted in Operation S36, an error notification is transmitted to the information processing device that has issued the printing request (Operation S38).

When it is determined in Operation 828 that the printer is in a “normal” state, the control unit 20 proceeds to Operation S30. When it is determined based on the print job data received from the engine control unit 26 that all the pages have been printed (YES in Operation S30), the control unit 20 proceeds to Operation 840, and an electronic mail transmission process is performed. The processing of Operation S40 has been described with reference to FIG. 5, and is not described here. Note that the control unit 20 may perform page management and may determine whether or not the last page has been printed based on resulting page management information. When the last page has not yet been printed, the control unit 20 receives print data of the next page as appropriate (Operation S32), and returns to Operation S24.

In the information processing system according to the present embodiment, therefore, a transmission condition relating to at least one of a print job and the state of a printer, and a transmission destination address are specified using a screen displayed by a printer driver installed in an information processing device. The specified transmission condition and transmission destination address are transmitted to the printer as print-related data together with print data. The printer obtains information relating to at least one of the print job and the state of the printer. When the received transmission condition is satisfied based on the information, the printer transmits electronic mail indicating the satisfaction of the transmission condition to the transmission destination address received at the same time as the transmission condition. That is, in this system, a printer is allowed to transmit electronic mail including desired information to a transmission destination address specified by an information processing device that executes printing.

For example, it is assumed that a user A wishes to provide a printout to a user C (the user of the client terminal 1-N) located near the printer 2-N located away from the user A by using the client terminal 1-1 and causing the printer 2-N to perform printing (see FIG. 1). In this case, when the user A starts the printer driver of the client terminal 1-1, the user A specifies the address of the client terminal 1-N as the transmission destination address, and specifies the transmission condition “at the time of completion of printing” (see FIG. 3). Thus, at the time of completion of printing, the printer 2-N transmits electronic mail including the character string “the printer 2-N has completed printing” to the client terminal 1-N. This allows the user C to obtain a printout from the printer 2-N at a desired time. Thus, the user A does not need to notify the user C of the completion of printing via telephone or electronic mail.

An error occurrence condition may be specified as a transmission condition at the same time, thus allowing a message “a xxx error has occurred during printing in the printer 2-N. Please fix the error.” to be transmitted to the user C via electronic mail when jamming or running out of paper has occurred during printing.

As described above, it is desirable that an information processing device be configured to be capable of writing a comment to each transmission destination address when starting a printer driver. This allows a user who wishes to print an object (in the above example, the user A) to add additional information such as content of the object to be printed to electronic mail transmitted from a printer.

In the embodiment described above, print-related data (first information) includes a transmission condition relating to at least one of a print job and the state of a printer, and a transmission destination address. However, this is merely an example. Print-related data transmitted from a client terminal (information processing device) to a printer may include only a transmission destination address. In this case, a transmission condition relating to at least one of a print job and the state of the printer is set in advance in the printer. When the transmission condition is satisfied, the printer transmits electronic mail indicating the satisfaction of the transmission condition to the transmission destination address.

According to an embodiment, the present invention triggers a message to be sent from a printer to a terminal upon occurrence of a condition set using a request from the terminal. Further, the message sent from the printer may be adjusted or modified to include content describing the condition that has occurred.

While an exemplary embodiment of the present invention has been described in detail, a printer, an information processing system, and an information processing method according to the present invention are not to be limited to those in the embodiment described above. It is to be understood that a variety of improvements and modifications may be made without departing from the scope of the present invention.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A printer connected with an information processing device via a network so as to communicate with the information processing device, the printer comprising:
a receiving unit configured to receive first information including a transmission destination address from the information processing device in accordance with a printing request from the information processing device;
an information obtaining unit configured to obtain information relating to at least one of a state of the printer and the printing request from the information processing device; and
an electronic mail transmission unit configured to transmit second information via an electronic mail to the transmission destination address included in the first information received in accordance with the printing request from the information processing device, where the second information relates to the at least one of the printing request and the state of the printer.

2. The printer according to claim 1, wherein the first information includes at least one certain condition or specified condition among a plurality of conditions relating to at least one of the state of the printer and the printing request, and
the electronic mail transmission unit causes the second information to include a character string when one of the at least one condition included in the first information is satisfied based on the information obtained by the information obtaining unit, the character string indicating that the condition is satisfied.

3. The printer according to claim 1, wherein the first information includes a character string input to the information processing device.

4. An information processing system having an information processing device, and a printer connected with the information processing device via a network so as to communicate with the information processing device, the system comprising:
the information processing device including:
an information generation unit configured to generate first information including a transmission destination address for each printing request to the printer, and
a transmission unit configured to transmit the first information to the printer for each printing request to the printer,
the printer including:
a receiving unit configured to receive the first information from the information processing device in accordance with a printing request from the information processing device,
an information obtaining unit configured to obtain information relating to at least one of a state of the printer and the printing request from the information processing device, and
an electronic mail transmission unit configured to transmit second information via an electronic mail to the transmission destination address included in the first information received in accordance with the printing request from the information processing device, where the second information relates to the at least one of the printing request and the state of the printer.

5. The information processing system according to claim 4, wherein the first information includes at least one certain condition or specified condition among a plurality of conditions relating to at least one of the printing request and the state of the printer, and
the electronic mail transmission unit causes the second information to include a character string when one of the at least one condition included in the first information is satisfied based on the information obtained by the information obtaining unit, the character string indicates that the condition is satisfied.

6. The information processing system according to claim 4, wherein the first information includes a character string input to the information processing device.

7. An information processing method performed between an information processing device and a printer connected with the information processing device via a network so as to communicate with the information processing device, the information processing method comprising:
generating first information including a transmission destination address in accordance with a printing request to the printer, by the information processing device, and transmitting the first information to the printer;
receiving, by the printer, the first information from the information processing device;
obtaining, by the printer, information relating to at least one of a state of the printer and the printing request; and
transmitting, by the printer, second information via an electronic mail to the transmission destination address included in the first information, where the second information relates to the at least one of the printing request and the state of the printer.

8. The information processing method according to claim 7, wherein the first information includes at least one certain condition or specified condition among a plurality of conditions relating to at least one of the state of the printer and the printing request, and
the second information is transmitted via an electronic mail in such a manner that the second information includes a character string when one of the at least one condition included in the first information is satisfied based on the obtained information relating to at least one of the state of the printer and the printing request, the character string indicates that the condition is satisfied.

9. The information processing method according to claim 7, wherein the first information includes a character string input to the information processing device.

10. A computer-readable recording medium having a program recorded thereon, the program being executed by a printer connected with an information processing device via a network so as to communicate with the information processing device, the program causing the printer to execute:
receiving first information including a transmission destination address from the information processing device in accordance with a printing request from the information processing device;
obtaining information relating to at least one of a state of the printer and the printing request from the information processing device; and
transmitting second information via an electronic mail to the transmission destination address included in the first information received in accordance with the printing request from the information processing device, the second information relating to the at least one of the printing request and the state of the printer.

11. The recording medium according to claim 10, wherein the first information includes at least one certain condition or specified condition among a plurality of conditions relating to at least one of the printing request and the state of the printer, and
the second information is transmitted via electronic mail in such a manner that the second information includes a character string when one of the at least one condition included in the first information is satisfied based on the obtained information relating to at least one of the state of the printer and the printing request, the character string indicates that the condition is satisfied.

12. The recording medium according to claim 10, wherein the first information includes a character string input to the information processing device.

13. A method of controlling a printer, comprising:
selecting a condition for triggering a message to be sent to a terminal from a printer by sending a print request to the printer; and
sending the message from the printer to the terminal when the printer determines that the condition has occurred.
